(19) United States
(12) Patent Application Publication
(10) Pub. No.: US 2026/0205624 A1
(43) Pub. Date: Jul. 16, 2026

(54) CODING OF DUPLICATE VERTICES

(71) Applicant: Tencent America LLC, Palo Alto, CA (US)

(72) Inventors: Fang-Yi CHAO, Palo Alto, CA (US); Chao HUANG, Palo Alto, CA (US); Shan LIU, San Jose, CA (US)

(73) Assignee: Tencent America LLC, Palo Alto, CA (US)

(21) Appl. No.: 19/435,365

(22) Filed: Dec. 29, 2025

Related U.S. Application Data
(60) Provisional application No. 63/744,275, filed on Jan. 12, 2025.

(51) Int. Cl. H04N 19/597; H04N 19/167; H04N 19/17

(52) U.S. Cl. CPC H04N 19/597; H04N 19/167; H04N 19/17

(57) ABSTRACT

Some aspects of the disclosure provide a method of mesh decoding. In some aspects, a bitstream is received, the bitstream includes coded information of a sequence of vertices in a polygon mesh. From the coded information, a flag is decoded, the flag indicates whether a current vertex in the sequence of vertices is a duplicate vertex with same position information as one of decoded vertices in the sequence of vertices. When the flag indicates that the current vertex is the duplicate vertex, an index signal is decoded, the index signal indicates an index of a decoded vertex with the same position information of the current vertex. A position of the current vertex is determined based on a decoded position of the decoded vertex.

### INCORPORATION BY REFERENCE

The present application claims the benefit of priority to U.S. Provisional Application No. 63/744,275 filed on Jan. 12, 2025. The entire disclosure of the prior application is hereby incorporated by reference in its entirety.

### TECHNICAL FIELD

The present disclosure describes aspects generally related to volumetric visual media coding.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

Various technologies are developed to capture and represent the world, such as objects in the world, environments in the world, and the like in 3-dimensional (3D) space. 3D representations of the world can enable more immersive forms of interaction and communication. For example, technology developments in 3D media processing, such as advances in three dimensional (3D) capture, 3D modeling, and 3D rendering, and the like have promoted the ubiquitous presence of 3D media contents across several platforms and devices. In an example, a baby's first step can be captured in one continent, media technology can allow grandparents to view (and maybe interact) and enjoy an immersive experience with the baby in another continent. According to an aspect of the disclosure, in order to improve immersive experience, 3D models are becoming ever more sophisticated, and the creation and consumption of 3D models occupy a significant amount of data resources, such as data storage, data transmission resources. In some examples, 3D meshes can be used as 3D representations of the world.

### SUMMARY

Aspects of the disclosure include bitstreams, methods and apparatuses for volumetric visual media coding (e.g., encoding and decoding). In some examples, an apparatus for volumetric visual media encoding/decoding includes processing circuitry.

Some aspects of the disclosure provide a method of mesh decoding. In some aspects, a bitstream is received, the bitstream includes coded information of a sequence of vertices in a polygon mesh. From the coded information, a flag is decoded, the flag indicates whether a current vertex in the sequence of vertices is a duplicate vertex with same position information as one of decoded vertices in the sequence of vertices. When the flag indicates that the current vertex is the duplicate vertex, an index signal is decoded, the index signal indicates an index of a decoded vertex with the same position information of the current vertex. A position of the current vertex is determined based on a decoded position of the decoded vertex.

Some aspects of the disclosure provide a method of mesh encoding. In some examples, a current vertex in a sequence of vertices in a polygon mesh is detected to be a duplicate vertex with same position information as an encoded vertex in the sequence of vertices. A flag is assigned with a value indicating that the current vertex is the duplicate vertex. An index signal is calculated, the index signal indicates an index of the encoded vertex with the same position information as the current vertex. The flag and the index signal are encoded into coded information of the polygon mesh in a bitstream.

Aspects of the disclosure also provide an apparatus for mesh decoding. The apparatus for mesh decoding including processing circuitry configured to implement any of the described methods for mesh decoding.

Aspects of the disclosure also provide an apparatus for mesh encoding. The apparatus for mesh encoding including processing circuitry configured to implement any of the described methods for mesh encoding.

Aspects of the disclosure also provide a non-transitory computer-readable medium storing instructions which, when executed by a computer, cause the computer to perform any of the described methods for mesh encoding/decoding.

### BRIEF DESCRIPTION OF THE DRAWINGS

Further features, the nature, and various advantages of the disclosed subject matter will be more apparent from the following detailed description and the accompanying drawings in which:

FIG. 1 shows a block diagram of a streaming system in some examples.

FIG. 2 is a schematic illustration of an example of a block diagram of a video decoder.

FIG. 3 is a schematic illustration of an example of a block diagram of a video encoder.

FIG. 4 shows an example of an encoding process for mesh processing according to an aspect of the disclosure.

FIG. 5 shows an example of a decoding process for mesh processing according to an aspect of the disclosure.

FIG. 6 shows a coding example of duplicate vertices according to an aspect of the disclosure.

FIG. 7 shows another coding example of duplicate vertices according to an aspect of the disclosure.

FIG. 8 shows a flow chart outlining a decoding process according to some aspects of the disclosure.

FIG. 9 shows a flow chart outlining an encoding process according to some aspects of the disclosure.

FIG. 10 is a schematic illustration of a computer system in accordance with an aspect.

### DETAILED DESCRIPTION

Aspects of the disclosure provide techniques in the field of volumetric visual media processing.

Volumetric visual media can refer to three-dimensional (3D) representations of people, objects, or environments that can be viewed from any angle. In some aspects, 2D images or videos generally record color values on a grid of pixels from a fixed perspective, but volumetric visual media can encode the spatial volume and enable free navigation, for example a viewer or camera can move freely around and through the content while maintaining correct perspectives.

In some aspects, volumetric visual media captures or synthesizes the physical extent of objects and environments. For example, volumetric visual media can include geometry information that defines shape of surfaces, and attribute information, such as surface color, texture, reflectance, and lighting interactions. In some examples, the volumetric visual media can also include dynamics information, such as motion, deformation, and temporal changes across frames.

Polygonal meshes can be used as a technique to represent 3D surfaces. The present disclosure uses polygonal meshes to illustrate various aspects of the present disclosure, and the various aspects can be applied to other techniques for 3D representation of the volumetric visual media.

In some aspects, a polygonal mesh (also referred to as a mesh or a mesh model) includes several polygons (also referred to as faces) that describe the surface of a volumetric object. Each polygon can be defined by vertices in three dimensional (3D) space and the information of how the vertices are connected, referred to as connectivity information. In some examples, the mesh also includes vertex attributes, such as colors, normals, displacements, and the like, that are associated with the mesh vertices. Further, in some examples, the mesh can include attributes associated with the surface of the mesh by exploiting mapping information that parameterizes the mesh with two dimensional (2D) attribute maps. Such mapping is usually described by a set of parametric coordinates, referred to as UV coordinates or texture coordinates, associated with the mesh vertices. 2D attribute maps are used to store high resolution attribute information, such as texture, normals, displacements, and the like. The 2D attribute maps can be used for various purposes such as texture mapping, shading and mesh reconstruction and the like.

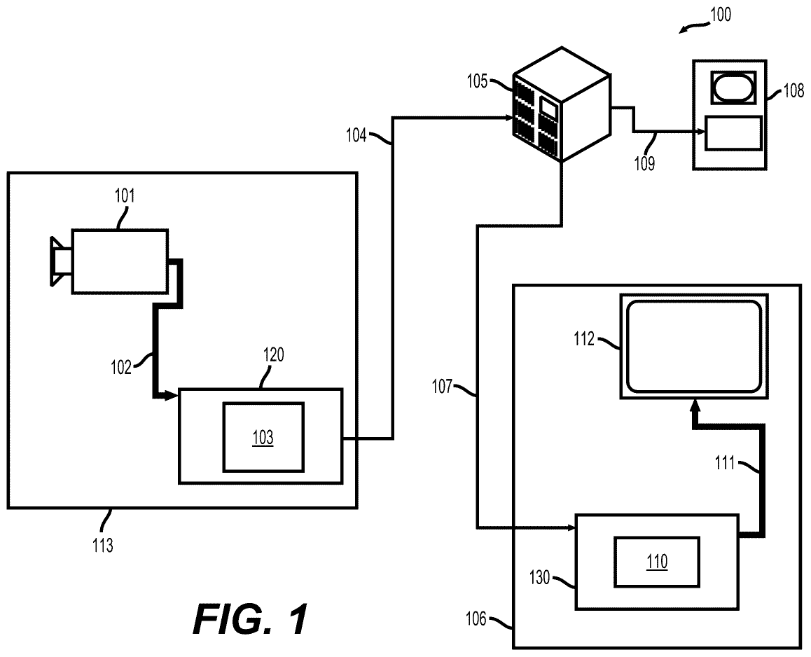

FIG. 1 shows a block diagram of a streaming system (100) in some examples. The streaming system (100) is an example of an application for the disclosed subject matter, a mesh encoder and a mesh decoder in a streaming environment. The disclosed subject matter can be applicable to other mesh enabled applications, including, for example, conferencing, 3D TV, streaming services, storing of compressed 3D data on digital media including CD, DVD, memory stick and the like, and so on.

The streaming system (100) includes a capture subsystem (113), that can include a 3D source (101), for example light detection and ranging (LIDAR) systems, 3D cameras, 3D scanners, a graphics generation component and the like for creating a stream of 3D data (102) that are uncompressed. In an example, the stream of 3D data (102) includes samples that are taken by the 3D camera system. The stream of 3D data (102), depicted as a bold line to emphasize a high data volume when compared to encoded 3D data (104) (or encoded bitstreams), can be processed by an electronic device (120) that includes a 3D encoder (103) coupled to the 3D source (101). The 3D encoder (103) can include hardware, software, or a combination thereof to enable or implement aspects of the disclosed subject matter as described in more detail below. The encoded 3D data (104) (or encoded bitstream), depicted as a thin line to emphasize the lower data volume when compared to the stream of 3D data (102), can be stored on a streaming server (105) for future use. One or more streaming client subsystems, such as client subsystems (106) and (108) in FIG. 1 can access the streaming server (105) to retrieve copies (107) and (109) of the encoded 3D data (104). A client subsystem (106) can include a 3D decoder (110), for example, in an electronic device (130). The 3D decoder (110) decodes the incoming copy (107) of the encoded 3D data and creates an outgoing stream of 3D representation (111) that can be rendered on a display (112) (e.g., display screen) or other rendering device (not depicted). In some streaming systems, the encoded 3D data (104), (107), and (109) (e.g., video bitstreams) can be encoded according to certain 3D coding/compression standards, such as mesh coding/compression standards and the like.

It is noted that the electronic devices (120) and (130) can include other components (not shown). For example, the electronic device (120) can include a 3D decoder (not shown) and the electronic device (130) can include a 3D encoder (not shown) as well.

It is also noted that, in some examples, the 3D encoders and/or the 3D decoders can use 2D encoding/decoding techniques. For example, 3D encoders and/or the 3D decoders can include video encoders or video decoders.

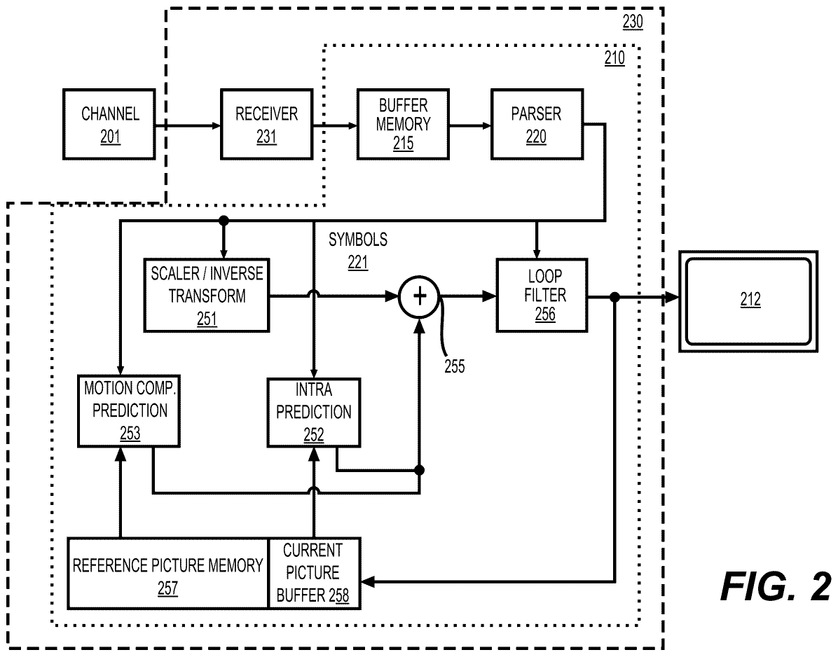

FIG. 2 shows an example of a block diagram of a video decoder (210). The video decoder (210) can be included in an electronic device (230). The electronic device (230) can include a receiver (231) (e.g., receiving circuitry). The video decoder (210) can be used in the 3D decoder (110) in the FIG. 1 example.

The receiver (231) may receive one or more coded video sequences, included in a bitstream for example, to be decoded by the video decoder (210). In an aspect, one coded video sequence is received at a time, where the decoding of each coded video sequence is independent from the decoding of other coded video sequences. The coded video sequence may be received from a channel (201), which may be a hardware/software link to a storage device which stores the encoded video data. The receiver (231) may receive the encoded video data with other data, for example, coded audio data and/or ancillary data streams, that may be forwarded to their respective using entities (not depicted). The receiver (231) may separate the coded video sequence from the other data. To combat network jitter, a buffer memory (215) may be coupled in between the receiver (231) and an entropy decoder/parser (220) (“parser (220)” henceforth). In certain applications, the buffer memory (215) is part of the video decoder (210). In others, it can be outside of the video decoder (210) (not depicted). In still others, there can be a buffer memory (not depicted) outside of the video decoder (210), for example to combat network jitter, and in addition another buffer memory (215) inside the video decoder (210), for example to handle playout timing. When the receiver (231) is receiving data from a store/forward device of sufficient bandwidth and controllability, or from an isosynchronous network, the buffer memory (215) may not be needed, or can be small. For use on best effort packet networks such as the Internet, the buffer memory (215) may be required, can be comparatively large and can be advantageously of adaptive size, and may at least partially be implemented in an operating system or similar elements (not depicted) outside of the video decoder (210).

The video decoder (210) may include the parser (220) to reconstruct symbols (221) from the coded video sequence. Categories of those symbols include information used to manage operation of the video decoder (210), and potentially information to control a rendering device such as a render device (212) (e.g., a display screen) that is not an integral part of the electronic device (230) but can be coupled to the electronic device (230), as shown in FIG. 2. The control information for the rendering device(s) may be in the form of Supplemental Enhancement Information (SEI) messages or Video Usability Information (VUI) parameter set fragments (not depicted). The parser (220) may parse/entropy-decode the coded video sequence that is received. The coding of the coded video sequence can be in accordance with a video coding technology or standard, and can follow various principles, including variable length coding, Huffman coding, arithmetic coding with or without context sensitivity, and so forth. The parser (220) may extract from the coded video sequence, a set of subgroup parameters for at least one of the subgroups of pixels in the video decoder, based upon at least one parameter corresponding to the group. Subgroups can include Groups of Pictures (GOPs), pictures, tiles, slices, macroblocks, Coding Units (CUs), blocks, Transform Units (TUs), Prediction Units (PUs) and so forth. The parser (220) may also extract from the coded video sequence information such as transform coefficients, quantizer parameter values, motion vectors, and so forth.

The parser (220) may perform an entropy decoding/parsing operation on the video sequence received from the buffer memory (215), so as to create symbols (221).

Reconstruction of the symbols (221) can involve multiple different units depending on the type of the coded video picture or parts thereof (such as: inter and intra picture, inter and intra block), and other factors. Which units are involved, and how, can be controlled by subgroup control information parsed from the coded video sequence by the parser (220). The flow of such subgroup control information between the parser (220) and the multiple units below is not depicted for clarity.

Beyond the functional blocks already mentioned, the video decoder (210) can be conceptually subdivided into a number of functional units as described below. In a practical implementation operating under commercial constraints, many of these units interact closely with each other and can, at least partly, be integrated into each other. However, for the purpose of describing the disclosed subject matter, the conceptual subdivision into the functional units below is appropriate.

A first unit is the scaler/inverse transform unit (251). The scaler/inverse transform unit (251) receives a quantized transform coefficient as well as control information, including which transform to use, block size, quantization factor, quantization scaling matrices, etc. as symbol(s) (221) from the parser (220). The scaler/inverse transform unit (251) can output blocks comprising sample values, that can be input into aggregator (255).

In some cases, the output samples of the scaler/inverse transform unit (251) can pertain to an intra coded block. The intra coded block is a block that is not using predictive information from previously reconstructed pictures, but can use predictive information from previously reconstructed parts of the current picture. Such predictive information can be provided by an intra picture prediction unit (252). In some cases, the intra picture prediction unit (252) generates a block of the same size and shape of the block under reconstruction, using surrounding already reconstructed information fetched from the current picture buffer (258). The current picture buffer (258) buffers, for example, partly reconstructed current picture and/or fully reconstructed current picture. The aggregator (255), in some cases, adds, on a per sample basis, the prediction information the intra prediction unit (252) has generated to the output sample information as provided by the scaler/inverse transform unit (251).

In other cases, the output samples of the scaler/inverse transform unit (251) can pertain to an inter coded, and potentially motion compensated, block. In such a case, a motion compensation prediction unit (253) can access reference picture memory (257) to fetch samples used for prediction. After motion compensating the fetched samples in accordance with the symbols (221) pertaining to the block, these samples can be added by the aggregator (255) to the output of the scaler/inverse transform unit (251) (in this case called the residual samples or residual signal) so as to generate output sample information. The addresses within the reference picture memory (257) from where the motion compensation prediction unit (253) fetches prediction samples can be controlled by motion vectors, available to the motion compensation prediction unit (253) in the form of symbols (221) that can have, for example X, Y, and reference picture components. Motion compensation also can include interpolation of sample values as fetched from the reference picture memory (257) when sub-sample exact motion vectors are in use, motion vector prediction mechanisms, and so forth.

The output samples of the aggregator (255) can be subject to various loop filtering techniques in the loop filter unit (256). Video compression technologies can include in-loop filter technologies that are controlled by parameters included in the coded video sequence (also referred to as coded video bitstream) and made available to the loop filter unit (256) as symbols (221) from the parser (220). Video compression can also be responsive to meta-information obtained during the decoding of previous (in decoding order) parts of the coded picture or coded video sequence, as well as responsive to previously reconstructed and loop-filtered sample values.

The output of the loop filter unit (256) can be a sample stream that can be output to the render device (212) as well as stored in the reference picture memory (257) for use in future inter-picture prediction.

Certain coded pictures, once fully reconstructed, can be used as reference pictures for future prediction. For example, once a coded picture corresponding to a current picture is fully reconstructed and the coded picture has been identified as a reference picture (by, for example, the parser (220)), the current picture buffer (258) can become a part of the reference picture memory (257), and a fresh current picture buffer can be reallocated before commencing the reconstruction of the following coded picture.

The video decoder (210) may perform decoding operations according to a predetermined video compression technology or a standard, such as ITU-T Rec. H.265. The coded video sequence may conform to a syntax specified by the video compression technology or standard being used, in the sense that the coded video sequence adheres to both the syntax of the video compression technology or standard and the profiles as documented in the video compression technology or standard. Specifically, a profile can select certain tools as the only tools available for use under that profile from all the tools available in the video compression technology or standard. Also necessary for compliance can be that the complexity of the coded video sequence is within bounds as defined by the level of the video compression technology or standard. In some cases, levels restrict the maximum picture size, maximum frame rate, maximum reconstruction sample rate (measured in, for example megasamples per second), maximum reference picture size, and so on. Limits set by levels can, in some cases, be further restricted through Hypothetical Reference Decoder (HRD) specifications and metadata for HRD buffer management signaled in the coded video sequence.

In an aspect, the receiver (231) may receive additional (redundant) data with the encoded video. The additional data may be included as part of the coded video sequence(s). The additional data may be used by the video decoder (210) to properly decode the data and/or to more accurately reconstruct the original video data. Additional data can be in the form of, for example, temporal, spatial, or signal noise ratio (SNR) enhancement layers, redundant slices, redundant pictures, forward error correction codes, and so on.

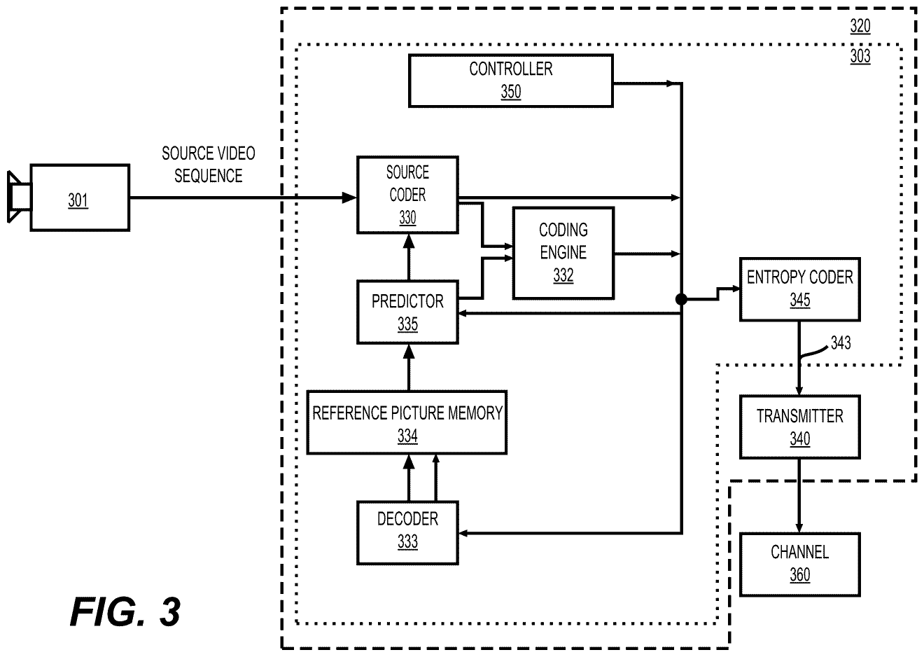

FIG. 3 shows an example of a block diagram of a video encoder (303). The video encoder (303) is included in an electronic device (320). The electronic device (320) includes a transmitter (340) (e.g., transmitting circuitry). The video encoder (303) can be used in the 3D encoder (103) in the FIG. 1 example.

The video encoder (303) may receive video samples from a video source (301) (that is not part of the electronic device (320) in the FIG. 3 example) that may obtain video image(s) to be coded by the video encoder (303). In another example, the video source (301) is a part of the electronic device (320).

The video source (301) may provide the source video sequence to be coded by the video encoder (303) in the form of a digital video sample stream that can be of any suitable bit depth (for example: 8 bit, 10 bit, 12 bit, . . . ), any colorspace (for example, BT.601 Y CrCB, RGB, . . . ), and any suitable sampling structure (for example Y CrCb 4:2:0, Y CrCb 4:4:4). In a media serving system, the video source (301) may be a storage device storing previously prepared video. In a videoconferencing system, the video source (301) may be a camera that captures local image information as a video sequence. Video data may be provided as a plurality of individual pictures that impart motion when viewed in sequence. The pictures themselves may be organized as a spatial array of pixels, wherein each pixel can comprise one or more samples depending on the sampling structure, color space, etc. in use. The description below focuses on samples.

According to an aspect, the video encoder (303) may code and compress the pictures of the source video sequence into a coded video sequence (343) in real time or under any other time constraints as required. Enforcing appropriate coding speed is one function of a controller (350). In some aspects, the controller (350) controls other functional units as described below and is functionally coupled to the other functional units. The coupling is not depicted for clarity. Parameters set by the controller (350) can include rate control related parameters (picture skip, quantizer, lambda value of rate-distortion optimization techniques, . . . ), picture size, group of pictures (GOP) layout, maximum motion vector search range, and so forth. The controller (350) can be configured to have other suitable functions that pertain to the video encoder (303) optimized for a certain system design.

In some aspects, the video encoder (303) is configured to operate in a coding loop. As an oversimplified description, in an example, the coding loop can include a source coder (330) (e.g., responsible for creating symbols, such as a symbol stream, based on an input picture to be coded, and a reference picture(s)), and a (local) decoder (333) embedded in the video encoder (303). The decoder (333) reconstructs the symbols to create the sample data in a similar manner as a (remote) decoder also would create. The reconstructed sample stream (sample data) is input to the reference picture memory (334). As the decoding of a symbol stream leads to bit-exact results independent of decoder location (local or remote), the content in the reference picture memory (334) is also bit exact between the local encoder and remote encoder. In other words, the prediction part of an encoder “sees” as reference picture samples exactly the same sample values as a decoder would “see” when using prediction during decoding. This fundamental principle of reference picture synchronicity (and resulting drift, if synchronicity cannot be maintained, for example because of channel errors) is used in some related arts as well.

The operation of the “local” decoder (333) can be the same as a “remote” decoder, such as the video decoder (210), which has already been described in detail above in conjunction with FIG. 2. Briefly referring also to FIG. 2, however, as symbols are available and encoding/decoding of symbols to a coded video sequence by an entropy coder (345) and the parser (220) can be lossless, the entropy decoding parts of the video decoder (210), including the buffer memory (215), and parser (220) may not be fully implemented in the local decoder (333).

In an aspect, a decoder technology except the parsing/entropy decoding that is present in a decoder is present, in an identical or a substantially identical functional form, in a corresponding encoder. Accordingly, the disclosed subject matter focuses on decoder operation. The description of encoder technologies can be abbreviated as they are the inverse of the comprehensively described decoder technologies. In certain areas a more detail description is provided below.

During operation, in some examples, the source coder (330) may perform motion compensated predictive coding, which codes an input picture predictively with reference to one or more previously coded picture from the video sequence that were designated as “reference pictures.” In this manner, the coding engine (332) codes differences between pixel blocks of an input picture and pixel blocks of reference picture(s) that may be selected as prediction reference(s) to the input picture.

The local video decoder (333) may decode coded video data of pictures that may be designated as reference pictures, based on symbols created by the source coder (330). Operations of the coding engine (332) may advantageously be lossy processes. When the coded video data may be decoded at a video decoder (not shown in FIG. 3), the reconstructed video sequence typically may be a replica of the source video sequence with some errors. The local video decoder (333) replicates decoding processes that may be performed by the video decoder on reference pictures and may cause reconstructed reference pictures to be stored in the reference picture memory (334). In this manner, the video encoder (303) may store copies of reconstructed reference pictures locally that have common content as the reconstructed reference pictures that will be obtained by a far-end video decoder (absent transmission errors).

The predictor (335) may perform prediction searches for the coding engine (332). That is, for a new picture to be coded, the predictor (335) may search the reference picture memory (334) for sample data (as candidate reference pixel blocks) or certain metadata such as reference picture motion vectors, block shapes, and so on, that may serve as an appropriate prediction reference for the new pictures. The predictor (335) may operate on a sample block-by-pixel block basis to find appropriate prediction references. In some cases, as determined by search results obtained by the predictor (335), an input picture may have prediction references drawn from multiple reference pictures stored in the reference picture memory (334).

The controller (350) may manage coding operations of the source coder (330), including, for example, setting of parameters and subgroup parameters used for encoding the video data.

Output of all aforementioned functional units may be subjected to entropy coding in the entropy coder (345). The entropy coder (345) translates the symbols as generated by the various functional units into a coded video sequence, by applying lossless compression to the symbols according to technologies such as Huffman coding, variable length coding, arithmetic coding, and so forth.

The transmitter (340) may buffer the coded video sequence(s) as created by the entropy coder (345) to prepare for transmission via a communication channel (360), which may be a hardware/software link to a storage device which would store the encoded video data. The transmitter (340) may merge coded video data from the video encoder (303) with other data to be transmitted, for example, coded audio data and/or ancillary data streams (sources not shown).

The controller (350) may manage operation of the video encoder (303). During coding, the controller (350) may assign to each coded picture a certain coded picture type, which may affect the coding techniques that may be applied to the respective picture. For example, pictures often may be assigned as one of the following picture types:

An Intra Picture (I picture) may be coded and decoded without using any other picture in the sequence as a source of prediction. Some video codecs allow for different types of intra pictures, including, for example Independent Decoder Refresh (“IDR”) Pictures.

A predictive picture (P picture) may be coded and decoded using intra prediction or inter prediction using a motion vector and reference index to predict the sample values of each block.

A bi-directionally predictive picture (B Picture) may be coded and decoded using intra prediction or inter prediction using two motion vectors and reference indices to predict the sample values of each block. Similarly, multiple-predictive pictures can use more than two reference pictures and associated metadata for the reconstruction of a single block.

Source pictures commonly may be subdivided spatially into a plurality of sample blocks (for example, blocks of 4×4, 8×8, 4×8, or 16×16 samples each) and coded on a block-by-block basis. Blocks may be coded predictively with reference to other (already coded) blocks as determined by the coding assignment applied to the blocks' respective pictures. For example, blocks of I pictures may be coded non-predictively or they may be coded predictively with reference to already coded blocks of the same picture (spatial prediction or intra prediction). Pixel blocks of P pictures may be coded predictively, via spatial prediction or via temporal prediction with reference to one previously coded reference picture. Blocks of B pictures may be coded predictively, via spatial prediction or via temporal prediction with reference to one or two previously coded reference pictures.

The video encoder (303) may perform coding operations according to a predetermined video coding technology or standard, such as ITU-T Rec. H.265. In its operation, the video encoder (303) may perform various compression operations, including predictive coding operations that exploit temporal and spatial redundancies in the input video sequence. The coded video data, therefore, may conform to a syntax specified by the video coding technology or standard being used.

In an aspect, the transmitter (340) may transmit additional data with the encoded video. The source coder (330) may include such data as part of the coded video sequence. Additional data may comprise temporal/spatial/SNR enhancement layers, other forms of redundant data such as redundant pictures and slices, SEI messages, VUI parameter set fragments, and so on.

A video may be captured as a plurality of source pictures (video pictures) in a temporal sequence. Intra-picture prediction (often abbreviated to intra prediction) makes use of spatial correlation in a given picture, and inter-picture prediction makes uses of the (temporal or other) correlation between the pictures. In an example, a specific picture under encoding/decoding, which is referred to as a current picture, is partitioned into blocks. When a block in the current picture is similar to a reference block in a previously coded and still buffered reference picture in the video, the block in the current picture can be coded by a vector that is referred to as a motion vector. The motion vector points to the reference block in the reference picture, and can have a third dimension identifying the reference picture, in case multiple reference pictures are in use.

In some aspects, a bi-prediction technique can be used in the inter-picture prediction. According to the bi-prediction technique, two reference pictures, such as a first reference picture and a second reference picture that are both prior in decoding order to the current picture in the video (but may be in the past and future, respectively, in display order) are used. A block in the current picture can be coded by a first motion vector that points to a first reference block in the first reference picture, and a second motion vector that points to a second reference block in the second reference picture. The block can be predicted by a combination of the first reference block and the second reference block.

Further, a merge mode technique can be used in the inter-picture prediction to improve coding efficiency.

According to some aspects of the disclosure, predictions, such as inter-picture predictions and intra-picture predictions, are performed in the unit of blocks. For example, according to the HEVC standard, a picture in a sequence of video pictures is partitioned into coding tree units (CTU) for compression, the CTUs in a picture have the same size, such as 64×64 pixels, 32×32 pixels, or 16×16 pixels. In general, a CTU includes three coding tree blocks (CTBs), which are one luma CTB and two chroma CTBs. Each CTU can be recursively quadtree split into one or multiple coding units (CUs). For example, a CTU of 64×64 pixels can be split into one CU of 64×64 pixels, or 4 CUs of 32×32 pixels, or 16 CUs of 16×16 pixels. In an example, each CU is analyzed to determine a prediction type for the CU, such as an inter prediction type or an intra prediction type. The CU is split into one or more prediction units (PUs) depending on the temporal and/or spatial predictability. Generally, each PU includes a luma prediction block (PB), and two chroma PBs. In an aspect, a prediction operation in coding (encoding/decoding) is performed in the unit of a prediction block. Using a luma prediction block as an example of a prediction block, the prediction block includes a matrix of values (e.g., luma values) for pixels, such as 8×8 pixels, 16×16 pixels, 8×16 pixels, 16×8 pixels, and the like.

It is noted that the encoders (103) and (303), and the decoders (110) and (210) can be implemented using any suitable technique. In an aspect, the encoders (103) and (303) and the decoders (110) and (210) can be implemented using one or more integrated circuits. In another aspect, the encoders (103) and (303), and the decoders (110) and (210) can be implemented using one or more processors that execute software instructions.

In some examples, the 3D data includes mesh models, and the 3D encoder (103) can include a mesh encoder, and the 3D decoder (110) can include a mesh decoder.

According to an aspect of the disclosure, a dynamic mesh is a mesh where at least one of the components (geometry information, connectivity information, mapping information, vertex attributes and attribute maps) varies with time. A dynamic mesh can be described by a sequence of meshes (also referred to as mesh frames). In some examples, mesh frames in a dynamic mesh can be representations of a surface of an object at different time, and each mesh frame is a representation of the surface of the object at a specific time (also referred to as a time instance). The dynamic mesh may require a large amount of data since the dynamic mesh may include a significant amount of information changing over time. Compression technologies of meshes can allow efficient storage and transmission of media contents in the mesh representation.

A dynamic mesh sequence may require a large amount of data since the dynamic mesh may include a significant amount of information changing over time. Therefore, efficient compression technologies may be used to store and transmit such contents.

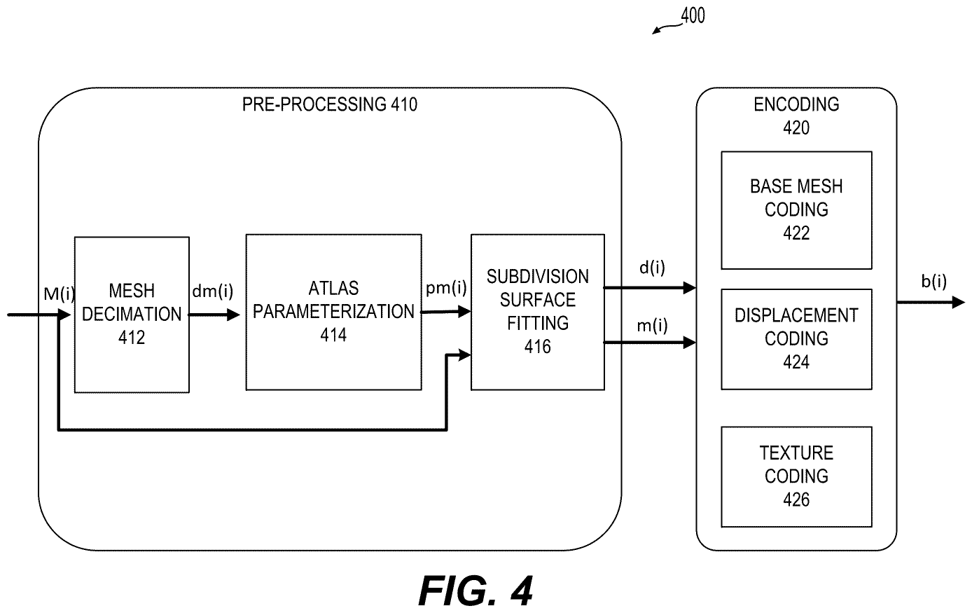

FIG. 4 shows an example of an encoding process (400) for mesh processing according to an aspect of the disclosure. As shown in FIG. 4, the encoding process (400) includes a pre-processing step (410) and an encoding step (420). The pre-processing step (410) receives an input mesh M(i) of ta current frame, and is configured to generate a base mesh m(i) of the current frame and a displacement field d(i) of the current frame according to the input mesh M(i) of the current frame. The displacement field d(i) of the current frame includes displacement vectors. The encoding step (420) is configured to encode the base mesh m(i), the displacement field d(i), and texture information of the base mesh m(i) in some examples. An index i is used to refer to the current frame. In an aspect, a mode decision method can be performed in the encoding process (400) to determine whether inter coding (also referred to as inter frame prediction or an inter mode), intra coding (also referred to as intra frame prediction or an intra mode), or the like is applied to the current frame. For example, the mode decision method can compare a cost of an intra mode and a cost of an inter mode and decide a coding mode of the base mesh m(i) of the current frame based on which one of the costs is smaller. In some examples, a skip mode is used to code the base mesh m(i). In an example, the skip mode is a special mode of the inter mode. In some aspects, the base mesh m(i) may be intra coded, or inter coded, or coded with the SKIP mode.

Still referring to FIG. 4, the pre-processing step (410) may include a mesh decimation process (412), a parameterization process such as an atlas parameterization process (414), and a subdivision surface fitting process (416). The mesh decimation process (412) is configured to down-sample vertices of the input mesh M(i) to generate a decimated mesh dm(i) that can include a plurality of decimated (or down-sampled) vertices. In an example, a number of the plurality of decimated vertices is less than a number of the vertices of the input mesh M(i). The parameterization process such as the atlas parameterization process (414) is configured to map the decimated mesh dm(i) onto a planar domain, such as onto a UV atlas (or a UV map), to generate a re-parameterized mesh pm(i). In an example, the atlas parameterization may be performed based on a video processing tool, such as a UV Atlas tool. The subdivision surface fitting process (416) is configured to take the re-parameterized mesh pm(i) and the input mesh M(i) as inputs and produce a based mesh m(i) together with the displacement field d(i) that includes the displacement vectors or a set of displacements. In an example of the subdivision surface fitting process (416), pm(i) is subdivided by using a subdivision scheme such as an iterative interpolation to obtain a subdivided mesh. The iterative interpolation includes inserting at each iteration a new point in a middle of each edge of the re-parameterized mesh pm(i). Any suitable subdivision scheme may be applied to subdivide pm(i). The displacement field d(i) is computed by determining a nearest point on a surface of the input mesh M(i) for each vertex of the subdivided mesh.

An advantage of the subdivided mesh may include that the subdivided mesh has a subdivision structure that allows efficient compression, while offering a faithful approximation of the input mesh. An increase in compression efficiency may be obtained due to the following properties. The decimated mesh dm(i) may have a low number of vertices and may be encoded and transmitted using a lower number of bits than the input mesh M(i) or the subdivided mesh. Referring to FIG. 4, the base mesh m(i) may be generated from the decimated mesh dm(i). In an example, the base mesh m(i) is the decimated mesh dm(i). As the subdivided mesh may be generated based on the subdivision method, the subdivided mesh may be automatically generated by the decoder when the base mesh or the decimated mesh is decoded (e.g., there is no need to use any information other than the subdivision scheme and a subdivision iteration count). At the decoder side, the displacement field d(i) may be generated by decoding the displacement vectors associated with the vertices of the subdivided mesh. Besides allowing for spatial/quality scalability, the subdivision structure enables efficient transforms such as wavelet decomposition, which can offer high compression performance.

In the FIG. 4 example, the encoding step (420) includes a base mesh coding (422), a displacement coding (424), a texture coding (426), and the like. The base mesh coding (422) is configured to encode geometric information of the base mesh m(i) associated with the current frame. In an intra encoding, the base mesh m(i) may be first quantized (e.g., using uniform quantization) and then encoded, for example, by the coding mode determined using the mode decision method. The coding mode may be the inter mode, the intra mode, the skip mode, or the like. The encoder used to intra code the base mesh m(i) may be referred to as a static mesh encoder. In the inter encoding, a reference base mesh (e.g., a reconstructed quantized reference base mesh m′ (j)) associated with a reference frame indicated by an index j may be used to predict the base mesh m(i) associated with the current frame indicated by the index i. The displacement coding (424) is configured to encode the displacement field d(i) that is generated in the pre-processing step (410). The displacement field d(i) may include a set of displacement vectors (or displacements) associated with the subdivided mesh vertices. The texture coding (426) is configured to encode attribute information of the base mesh m(i). The attribute information may include texture, normal, color, and/or the like. The attribute information may be encoded based on a suitable codec, such as High-Efficiency Video Coding (HEVC) or Versatile Video Coding (VVC).

In an aspect, referring to FIG. 4, a mesh encoding process such as the encoding process (420) starts with a pre-processing (e.g., the pre-processing step (410)). The pre-processing may convert the input mesh (e.g., the input dynamic mesh) M(i) into the base mesh m(i) together with the displacement field d(i) including a set of displacements (or a set of displacement vectors). The encoding step (420) may compress outputs (e.g., m(i), d(i), and the like) from the pre-processing and generate a compressed bitstream b(i). The compressed bitstream b(i) may include a compressed base mesh bitstream, a compressed displacement field bitstream, a compressed attribute bitstream, and/or the like.

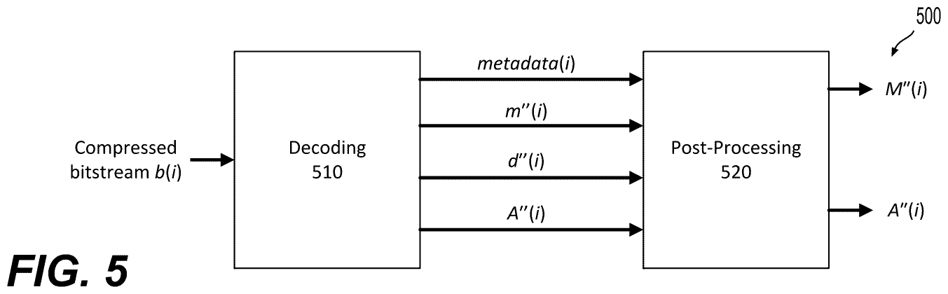

FIG. 5 shows an example of a decoding process (500) for mesh processing according to an aspect of the disclosure. The decoding process (500) may include a decoding step (510) and a post-processing step (520). A compressed bitstream b(i) may be fed to the decoding step (510). In an example, such as for a lossless transmission, the compressed bitstream b(i) is the output b(i) from the encoding process (400). The decoding step (510) may extract various sub-bitstreams such as the compressed base mesh sub-stream, the compressed displacement field sub-stream, the compressed attribute sub-stream, and/or the like. The decoding step (510) may decompress the sub-bitstreams to generate the following components: patch metadata indicated by metadata(i), a decoded base mesh m″(i), a decoded displacement field (including displacements) d″(i), a decoded attribute map A″(i), and/or the like.

In an aspect, the base mesh sub-stream may be fed to a mesh decoder to generate a reconstructed quantized base mesh m′(i). The decoded base mesh (or reconstructed base mesh) m″(i) may be obtained by applying an inverse quantization to m′(i). The displacement field sub-stream including packed and quantized wavelet coefficients that are encoded may be decoded by a video and/or image decoder. Image unpacking and inverse quantization may be applied to the packed quantized wavelet coefficients that are reconstructed to obtain the unpacked and unquantized transformed coefficients (e.g., wavelet coefficients). An inverse wavelet transform may be applied to the unpacked and unquantized wavelet coefficients to generate the decoded displacement field (or reconstructed displacement) d″(i).

The decoded components (e.g., including metadata(i), m″(i), d″(i), A″(i), and/or the like) may be fed to a post-processing step (520). A mesh (also referred to as a decoded/reconstructed mesh) M″(i) may be generated by the post-processing step (520) based on m″(i) and d″(i). In an example, the mesh M″(i) (also referred to as a reconstructed deformed mesh DM(i)) may be obtained by subdividing m″(i) using a subdivision scheme and applying the reconstructed displacements d″(i) to vertices of a subdivided mesh. In an example, the DM (i) may include the displaced curve. In an example, when the encoding process (400), the decoding process (500), and the transmission are lossless, the mesh M″(i) may be identical to the input mesh M(i). When one of the encoding process (400), the decoding process (500), and the transmission is lossy, M″(i) is different from M(i). In various examples, the difference, if any, between M″(i) and M(i) may be relatively small. In an example, an attribute map A″(i) is also generated by the post-processing step (520).

In some examples, the mesh can also include attributes, such as color, normal, and the like, associated with the vertices. The attributes can be associated with the surface of the mesh by exploiting mapping information that parameterizes the mesh with 2D attribute maps. The mapping information is usually described by a set of parametric coordinates, referred to as UV coordinates or texture coordinates, associated with the mesh vertices. 2D attribute maps (referred to as texture maps in some examples) are used to store high resolution attribute information such as texture, normals, displacements etc. Such information could be used for various purposes such as texture mapping and shading.

According to some aspects, a polygon mesh encoder is used for base mesh coding. The polygon mesh encoder includes a geometry encoder and an attribute encoder. The geometry encoder is configured to generate a geometry compressed bitstream and the attribute encoder is configured to generate an attribute compressed bitstream. The geometry compressed bitstream and the attribute compressed bitstream are multiplexed into a final bitstream in some examples.

In some examples, the geometry information of a polygon mesh is described by a set of 3D positions associated with the vertices of the polygon mesh. In an example, (x,y,z) coordinates can be used to describe the 3D positions of the vertices, and are also referred to as 3D coordinates.

According to some aspects of the disclosure, duplicate vertices with the same position (e.g., same coordinate values) can be used in polygon meshes. For example, when multiple cores are used and configured for parallel processing, duplicate vertices can enable the multiple cores to process in parallel. Some aspects of the present disclosure provide coding techniques for duplicate vertices with the same position values. It is noted that the coding techniques for duplicate vertices can be used for coding attribute information, such as texture coordinates, UV coordinates, normals, and the like.

In some examples, the geometry or attribute vector coding can proceed in two steps. In the first step, position prediction is performed; and in the second step, prediction residuals generated in the first step are encoded. A polygon mesh can include multiple duplicate vertices in geometry and/or attributes that share the same position values. Coding efficiency can be improved by avoiding coding of duplicate vertices.

In an aspect, to avoid coding the duplicate vertices, the coding of the position information of the duplicate vertices can be skipped and the index information of the already encoded duplicate vertex can be signaled instead. It is noted that this technique can be applied to geometry information and/or any attribute information, such as texture coordinates, normals, and the like.

In some examples, at the encoder side, the encoder can check whether the position of a current vertex has been encoded. When the current vertex is a new vertex (e.g., the position of the current vertex has not been encoded before), the encoder can signal to indicate the current vertex is a new vertex (e.g., encode 1 to indicate the current vertex is new) and encode the position of the current vertex directly (e.g., by a first step of prediction and a second step of encoding residuals). When the current vertex is an old vertex (e.g., the position of the current vertex has been encoded before, also referred to as duplicate vertex), the encoder can signal to indicate the current vertex is a duplicate vertex (e.g., encode 0 to indicate the current vertex is a duplicate vertex) and encodes a delta index between a first vertex index of the current index and a second vertex index of a previously already encoded vertex with the same position as the current vertex.

In some examples, a list of unique vertices can be built, the list of unique vertices can keep track of the positions of the unique vertices and the vertex indices of the unique vertices. For each current vertex, the current vertex can be determined to be a new vertex or a duplicate vertex based on the list of unique vertices. When the current vertex is a duplicate vertex, the delta vertex can be signaled according to the list of unique vertices. In some examples, the list of unique vertices keeps track of the indices of the unique vertices that appear first (e.g., first occurrence vertices) in the set of vertices of the polygon mesh. In some examples, the list of unique vertices keeps track of the indices of the unique vertices that appear most recently (e.g., latest occurrence vertices) in the set of vertices of the polygon mesh.

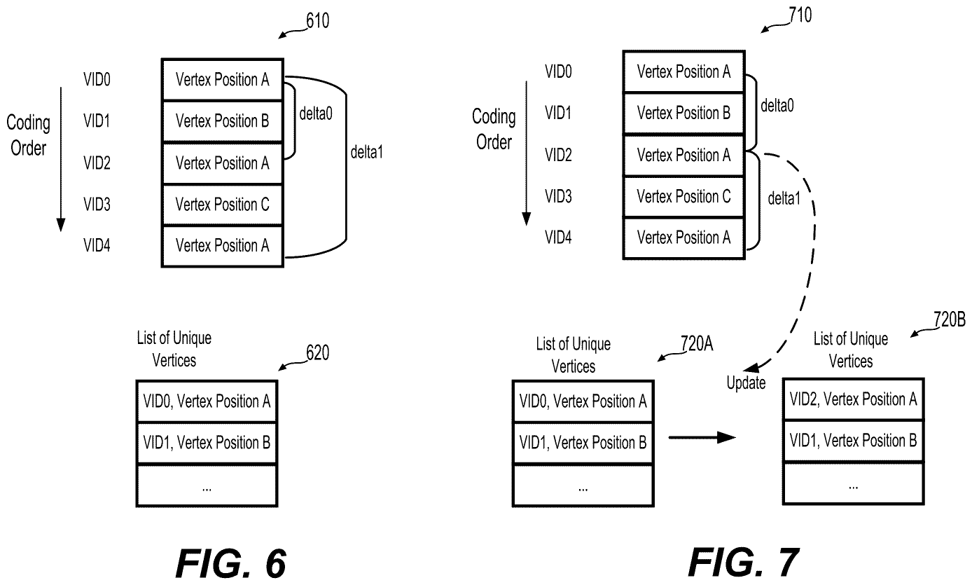

FIG. 6 shows a coding example of duplicate vertices according to an aspect of the disclosure. In an example, an encoder receives a set of vertices, such as a set of vertices (610) to encodes. Based on the set of vertices (610), the encoder generates and keeps track of a list of unique vertices (620). The list of unique vertices (620) keeps the positions of the unique vertices and the indices of the unique vertices that appear first in the set of vertices (610). When to code a duplicate vertex for a unique vertex in the list of unique vertices (620), a delta index between the duplicate vertex and the unique vertex in the list of unique vertices (620) can be coded.

In the FIG. 6 example, a first vertex with vertex index VID0 has vertex position A. When the first vertex is determined to be a new vertex, the vertex position A and the vertex index VID0 are kept in the list of unique vertices (620), and the vertex position A is suitably signaled (e.g., as a combination of prediction and residual signaling). Further, a second vertex with vertex index VID1 has vertex position B. When the second vertex is determined to be a new vertex, the vertex position B and the vertex index VID1 are kept in the list of unique vertices (620), and the vertex position B is suitably signaled (e.g., as a combination of prediction and residual signaling). Further, a third vertex with vertex index VID2 has vertex position A. The third vertex can be determined to be a duplicate vertex based on the list of unique vertices (620). In an example, a delta index delta0 between the VID2 and VID0 can be calculated based on the list of unique vertices (620), and the delta index delta0 can be signaled instead of signaling the vertex position A again.

Further, in the FIG. 6 example, a fifth vertex with vertex index VID4 has vertex position A. The fifth vertex can be determined to be a duplicate vertex based on the list of unique vertices (620). In an example, a delta index delta1 between the VID4 and VID0 can be calculated based on the list of unique vertices (620), and the delta index delta1 can be signaled instead of signaling the vertex position A again.

FIG. 7 shows another coding example of duplicate vertices according to an aspect of the disclosure. In an example, an encoder receives a set of vertices, such as a set of vertices (710) to encodes. Based on the set of vertices (710), the encoder generates and keeps track of a list of unique vertices (720) (as shown by (720A) and (720B)). The list of unique vertices keeps the position of the unique vertices and the indices of the unique vertices that appear latest (e.g., most recent) in the set of vertices. When to code a duplicate vertex for a unique vertex in the list of unique vertices, a delta index between the duplicate vertex and the unique vertex in the list of unique vertices (720) can be coded. The list of unique vertices (720) can be updated after the duplicate vertex is coded.

In the FIG. 7 example, a first vertex with vertex index VID0 has vertex position A. When the first vertex is determined to be a new vertex, the vertex position A and the vertex index VID0 are kept in the list of unique vertices (720A), and the vertex position A is suitably signaled (e.g., as a combination of prediction and residual signaling). Further, a second vertex with vertex index VID1 has vertex position B. When the second vertex is determined to be a new vertex, the vertex position B and the vertex index VID1 are kept in the list of unique vertices (720A), and the vertex position B is suitably signaled (e.g., as a combination of prediction and residual signaling). Further, a third vertex with vertex index VID2 has vertex position A. The third vertex can be determined to be a duplicate vertex based on the list of unique vertices (720A). In an example, a delta index delta0 between the VID2 and VID0 can be calculated based on the list of unique vertices (720A), and the delta index delta0 can be signaled instead of signaling the vertex position A again. Further, the list of unique vertices (720A) is updated to the list of unique vertices (720B) with the index VID2 being kept with the vertex position A, the index VID2 is the index of the latest vertex (e.g., most recent vertex) with the vertex position A at the time.

Further, in the FIG. 7 example, a fifth vertex with vertex index VID4 has vertex position A. The fifth vertex can be determined to be a duplicate vertex based on the list of unique vertices (720B). In an example, a delta index delta1 between the VID4 and VID2 can be calculated based on the list of unique vertices (720B), and the delta index delta1 can be signaled instead of signaling the vertex position A again. It is noted that the list of unique vertices (720B) can be updated (not shown) with the index VID4 being kept with the vertex position A, the index VID4 is the index of the latest vertex (most recent vertex) with the vertex position A at the time.

In the FIG. 7 example, the index of the unique vertex can be updated to the new index (also referred to as index of the latest occurrence vertex, index of the most recent vertex) when its duplicate vertex is coded. So that the delta index (value) can be reduced, and a reduced number of coding bits can be used.

In some aspects, to code a current delta index, a last delta index (also referred to as a most recent delta index) can be used to decrease coding bits for coding the current delta index. Since the delta indices are coded sequentially, the last delta index is already coded in the bitstream when the current delta index is going to be coded. In some examples, a difference (e.g., signaled and denoted by signaled index) between the current delta index (denoted by deltaIndex) and the last delta index (denoted by lastDeltaIndex) in the bitstream is encoded, for example, according to Eq. (1):

$$signaled index = deltaIndex - lastDeltaIndex \qquad Eq . ( 1 )$$

It is noted that the last delta index can be initialized as zero at the beginning of coding the set of vertices.

In the decoder, the last delta index can be initialized as zero. The delta index difference that is decoded from the bitstream can be added with the last delta index to recover the delta index for the current vertex. The recovered delta index is used to update the last delta index.

In some aspects, a counter of the unique vertices that have been coded can be set. Once the counter is equal to the total number of unique vertices, that means all the rest vertices that are going to be coded are duplicated, thus no need to encode 0 to indicate it. In some examples, the total number of unique vertices is encoded in the bitstream, such as in a frame header. In the decoder, this counter is set for the unique vertex (new vertex) that has been decoded. Once this counter is equal to the total number of unique vertices, that means all the rest vertices to be decoded are duplicated, no need to decode 0 to indicate it.

In some aspects, at the encoder side, first bits that will be spent on encoding the delta index and second bits that will be spent on encoding the positions are estimated for a duplicate vertex. The one that will use fewer bits will be used to encode the duplicate vertex. For example, when the first bits that will be spent on encoding the delta index are fewer, the encoder can encode 0 to indicate this is an old vertex (duplicate vertex) and then encode the delta index. When the second bits that will be spent on encoding the position (e.g., a combination of prediction and residual signaling) are fewer, the encoder can encode 1 and then encode the vertex's position (e.g., a combination of prediction and residual signaling).

In an aspect, some criteria can be applied to adaptively enable/disable the coding techniques of duplicate vertices in the present disclosure, and one bit can be encoded to inform the decoder whether coding techniques of duplicate vertices in the present disclosure is enabled or not.

In some examples, the coding techniques of duplicate vertices can be disabled when there is no duplicate vertex, for example all the vertices have unique positions. In some examples, the coding techniques of duplicate vertices can be disabled when the ratio of duplicate vertices is smaller than a threshold. In an example, the ratio of duplicate vertices Ratio_{duplicateVertices} can be computed as Eq. (2):

$${Ratio}_{duplicateVertices} = ( vertexCount - uniquePosCount ) / vertexCount \qquad Eq . ( 2 )$$

where vertexCount denotes the total number of vertices and uniquePosCount denotes the number of unique vertices that have unique positions.

In an aspect, an adaptive threshold can be computed based on the range of positions, where the range can be represented as the bit-width of the bounding box of all the vertices' positions. For example, an adaptive threshold can be computed as Eq. (3):

$${Threshould}_{adaptive} = \frac{3}{( {Range}_{positions} - 10 ) * 10 + 5} \qquad Eq . ( 3 )$$

where Rangeₚₒₛᵢₜᵢₒₙₛ is calculated according to Eq. (4):

$${Range}_{positions} = bitwidth ( max ( {boundingBox}_{allPositions} ) ) \qquad Eq . ( 4 )$$

It is noted that in Eq. (4), max (boundingBox_{allPositions}) denotes the maximum length of the bounding box among all dimensions. It is also noted that the parameters in Eq. (3) can be changed depending on the application or can have experimental values. The adaptive threshold can also be computed based on the actual bounding box of the vertices' positions.

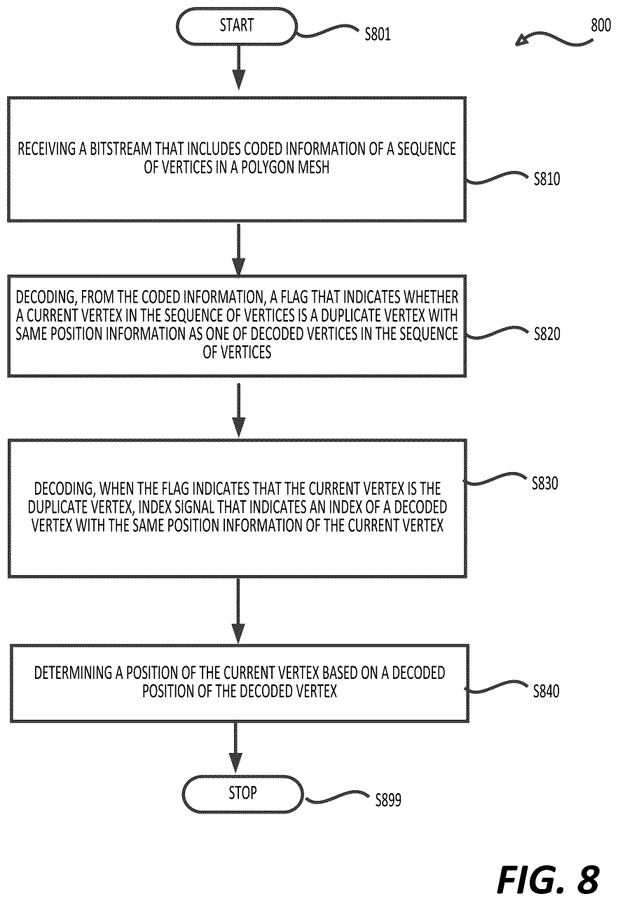

FIG. 8 shows a flow chart outlining a process (800) according to an aspect of the disclosure. The process (800) can be used in a mesh decoder. In various aspects, the process (800) is executed by processing circuitry, such as the processing circuitry that performs functions of the 3D decoder (110), and the like. In some aspects, the process (800) is implemented in software instructions, thus when the processing circuitry executes the software instructions, the processing circuitry performs the process (800). The process starts at (S801) and proceeds to (S810).

At (S810), a bitstream is received, the bitstream includes coded information of a sequence of vertices in a polygon mesh.

At (S820), from the coded information, a flag is decoded, the flag indicates whether a current vertex in the sequence of vertices is a duplicate vertex with same position information as one of decoded vertices in the sequence of vertices.

At (S830), when the flag indicates that the current vertex is the duplicate vertex, an index signal is decoded, the index signal indicates an index of a decoded vertex with the same position information of the current vertex.

At (S840), a position of the current vertex is determined based on a decoded position of the decoded vertex.

In some examples, the decoded vertex is a first occurrence vertex that has the same position information as the current vertex. In some examples, the decoded vertex is a latest occurrence vertex that has the same position information as the current vertex.

In an aspect, the index signal indicates a current delta index between a current index of the current vertex and the index of the decoded vertex, and the index of the decoded vertex is determined based on the current index of the current vertex and the index signal. In some examples, the index signal is a difference between the current delta index and a latest delta index that is decoded before the current delta index. To determine the index of the decoded vertex, the current delta index is calculated according to the index signal and the latest delta index, then the index of the decoded vertex is computed based on the current index of the current vertex and the current delta index. Further, the latest delta index is updated to be the current delta index.

In an aspect, from the coded information, a total number of unique vertices in the sequence of vertices is decoded. A counter can count a number of unique vertices of the decoded vertices at the time of decoding the current vertex. The flag is inferred with a value indicating that the current vertex is the duplicate vertex when the counted number of unique vertices is equal to the total number of unique vertices.

In some examples, the flag indicates that the current vertex is not the duplicate vertex. Then, a predicted position of the current vertex is generated. From the coded information, a prediction residual to the predicted position is decoded. The position of the current vertex is determined based on the predicted position and the prediction residual.

In some examples, a disable/enable flag is decoded, the disable/enable flag indicates whether a coding tool for duplicate vertices (such as tools in the present disclosure) is disabled/enabled.

Then, the process proceeds to (S899) and terminates.

The process (800) can be suitably adapted. Step(s) in the process (800) can be modified and/or omitted. Additional step(s) can be added. Any suitable order of implementation can be used.

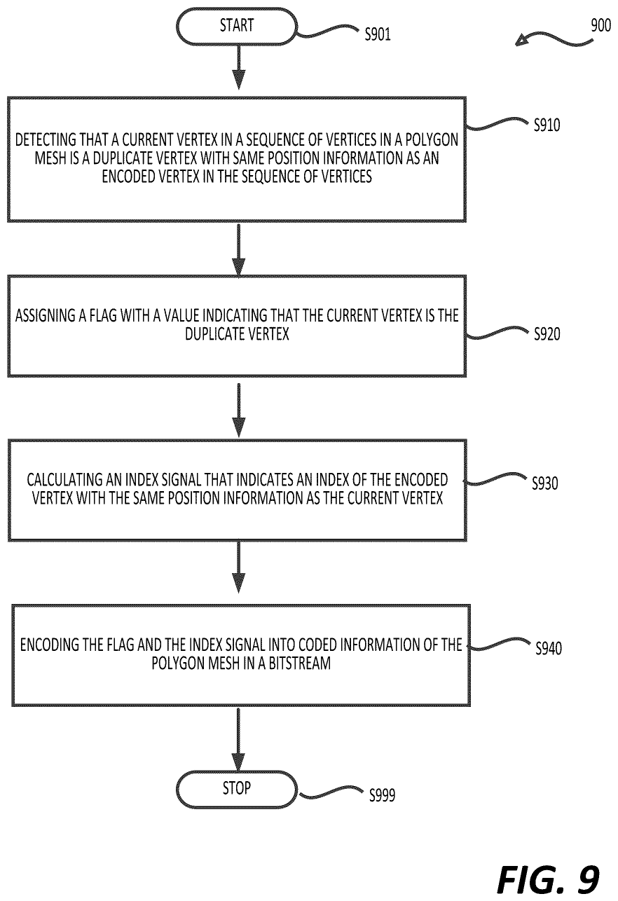

FIG. 9 shows a flow chart outlining a process (900) according to an aspect of the disclosure. The process (900) can be used in a mesh encoder. In various aspects, the process (900) is executed by processing circuitry, such as the processing circuitry that performs functions of the 3D encoder (103), and the like. In some aspects, the process (900) is implemented in software instructions, thus when the processing circuitry executes the software instructions, the processing circuitry performs the process (900). The process starts at (S901) and proceeds to (S910).

At (S910), a current vertex in a sequence of vertices in a polygon mesh is detected to be a duplicate vertex with same position information as an encoded vertex in the sequence of vertices.

At (S920), a flag is assigned with a value indicating that the current vertex is the duplicate vertex.

At (S930), an index signal is calculated, the index signal indicates an index of the encoded vertex with the same position information as the current vertex.

At (S940), the flag and the index signal are encoded into coded information of the polygon mesh in a bitstream.

In some aspects, the encoded vertex is a first occurrence vertex that has the same position information as the current vertex. In some aspects, the encoded vertex is a latest occurrence vertex that has the same position information as the current vertex.

In some examples, the index signal is calculated based on a current delta index between a current index of the current vertex and the index of the encoded vertex.

In some examples, to calculate the index signal, a difference between the current delta index and a latest delta index that is encoded before the current delta index is calculated to be the index signal. The latest delta index is updated to be the current delta index.

In some examples, a number of unique vertices that are encoded before the current vertex is counted, and the flag is skipped in the encoding when the number of unique vertices is equal to a total number of unique vertices in the sequence of vertices.

In some examples, the current vertex is detected not to be a duplicate vertex. Then, the flag is assigned with a value that indicates that the current vertex is a new vertex. A predicted position of the current vertex is generated, and a prediction residual of the position of the current vertex to the predicted position is calculated. The flag and the prediction residual are encoded into the coded information of the polygon mesh.

In some examples, a first number of first bits for encoding the index signal is estimated, and a second number of second bits for encoding a prediction residual of the current vertex is estimated. The flag and the index signal are encoded into the coded information when the first number is less than the second number. The prediction residual is encoded into the coded information when the second number is less than the first number.

In some examples, a disable/enable flag is encoded into the coded information, the disable/enable flag indicates whether a coding tool for duplicate vertices is disabled/enabled.

In an example, it is determined that the sequence of vertices has no duplicate vertex. Then, one or more coding tools for coding duplicate vertices are disabled accordingly.

In some examples, a ratio of duplicate vertices is compared to a threshold. One or more coding tools for coding duplicate vertices are disabled when the ratio is smaller than the threshold. In an example, the threshold is predefined. In another example, the threshold is computed based on a range of vertex positions of the sequence of vertices. In another example, the threshold is computed based on a bounding box of the vertex positions of the sequence of vertices.

Then, the process proceeds to (S999) and terminates.

The process (900) can be suitably adapted. Step(s) in the process (900) can be modified and/or omitted. Additional step(s) can be added. Any suitable order of implementation can be used.

According to an aspect of the disclosure, a method of processing mesh data is provided. In the method, a conversion between a mesh media file and a bitstream of mesh media data is performed according to a format rule. For example, the bitstream may be a bitstream that is decoded/encoded in any of the decoding and/or encoding methods described herein. The format rule may specify one or more constraints of the bitstream and/or one or more processes to be performed by the decoder and/or encoder.

In an example, the bitstream carries coded information of a sequence of vertices in a polygon mesh. The format rule specifies that: from the coded information, a flag that indicates whether a current vertex in the sequence of vertices is a duplicate vertex with same position information as one of decoded vertices in the sequence of vertices is decoded; when the flag indicates that the current vertex is the duplicate vertex, index signal that indicates an index of a decoded vertex with the same position information of the current vertex is decoded; and a position of the current vertex is determined based on a decoded position of the decoded vertex.

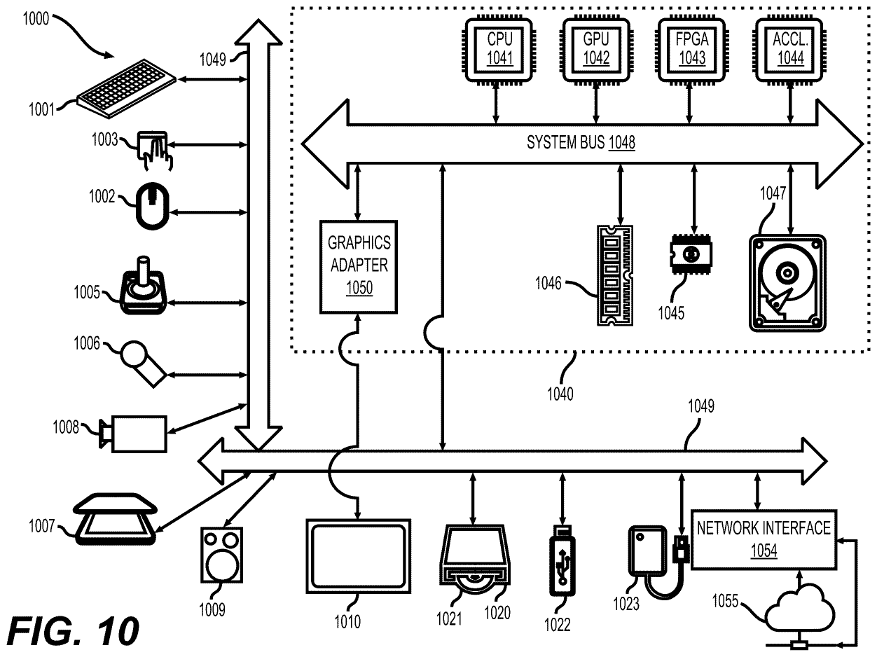

The techniques described above, can be implemented as computer software using computer-readable instructions and physically stored in one or more computer-readable media. For example, FIG. 10 shows a computer system (1000) suitable for implementing certain aspects of the disclosed subject matter.

The computer software can be coded using any suitable machine code or computer language, that may be subject to assembly, compilation, linking, or like mechanisms to create code comprising instructions that can be executed directly, or through interpretation, micro-code execution, and the like, by one or more computer central processing units (CPUs), Graphics Processing Units (GPUs), and the like.

The instructions can be executed on various types of computers or components thereof, including, for example, personal computers, tablet computers, servers, smartphones, gaming devices, internet of things devices, and the like.

The components shown in FIG. 10 for computer system (1000) are examples and are not intended to suggest any limitation as to the scope of use or functionality of the computer software implementing aspects of the present disclosure. Neither should the configuration of components be interpreted as having any dependency or requirement relating to any one or combination of components illustrated in the example aspect of computer system (1000).

Computer system (1000) may include certain human interface input devices. Such a human interface input device may be responsive to input by one or more human users through, for example, tactile input (such as: keystrokes, swipes, data glove movements), audio input (such as: voice, clapping), visual input (such as: gestures), olfactory input (not depicted). The human interface devices can also be used to capture certain media not necessarily directly related to conscious input by a human, such as audio (such as: speech, music, ambient sound), images (such as: scanned images, photographic images obtain from a still image camera), video (such as two-dimensional video, three-dimensional video including stereoscopic video).

Input human interface devices may include one or more of (only one of each depicted): keyboard (1001), mouse (1002), trackpad (1003), touch screen (1010), data-glove (not shown), joystick (1005), microphone (1006), scanner (1007), camera (1008).

Computer system (1000) may also include certain human interface output devices. Such human interface output devices may be stimulating the senses of one or more human users through, for example, tactile output, sound, light, and smell/taste. Such human interface output devices may include tactile output devices (for example tactile feedback by the touch-screen (1010), data-glove (not shown), or joystick (1005), but there can also be tactile feedback devices that do not serve as input devices), audio output devices (such as: speakers (1009), headphones (not depicted)), visual output devices (such as screens (1010) to include CRT screens, LCD screens, plasma screens, OLED screens, each with or without touch-screen input capability, each with or without tactile feedback capability—some of which may be capable to output two dimensional visual output or more than three dimensional output through means such as stereographic output; virtual-reality glasses (not depicted), holographic displays and smoke tanks (not depicted)), and printers (not depicted).

Computer system (1000) can also include human accessible storage devices and their associated media such as optical media including CD/DVD ROM/RW (1020) with CD/DVD or the like media (1021), thumb-drive (1022), removable hard drive or solid state drive (1023), legacy magnetic media such as tape and floppy disc (not depicted), specialized ROM/ASIC/PLD based devices such as security dongles (not depicted), and the like.

Those skilled in the art should also understand that term “computer readable media” as used in connection with the presently disclosed subject matter does not encompass transmission media, carrier waves, or other transitory signals.

Computer system (1000) can also include an interface (1054) to one or more communication networks (1055). Networks can for example be wireless, wireline, optical. Networks can further be local, wide-area, metropolitan, vehicular and industrial, real-time, delay-tolerant, and so on. Examples of networks include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Certain networks commonly require external network interface adapters that attached to certain general purpose data ports or peripheral buses (1049) (such as, for example USB ports of the computer system (1000)); others are commonly integrated into the core of the computer system (1000) by attachment to a system bus as described below (for example Ethernet interface into a PC computer system or cellular network interface into a smartphone computer system). Using any of these networks, computer system (1000) can communicate with other entities. Such communication can be uni-directional, receive only (for example, broadcast TV), uni-directional send-only (for example CANbus to certain CANbus devices), or bi-directional, for example to other computer systems using local or wide area digital networks. Certain protocols and protocol stacks can be used on each of those networks and network interfaces as described above.

Aforementioned human interface devices, human-accessible storage devices, and network interfaces can be attached to a core (1040) of the computer system (1000).

The core (1040) can include one or more Central Processing Units (CPU) (1041), Graphics Processing Units (GPU) (1042), specialized programmable processing units in the form of Field Programmable Gate Areas (FPGA) (1043), hardware accelerators for certain tasks (1044), graphics adapters (1050), and so forth. These devices, along with Read-only memory (ROM) (1045), Random-access memory (1046), internal mass storage such as internal non-user accessible hard drives, SSDs, and the like (1047), may be connected through a system bus (1048). In some computer systems, the system bus (1048) can be accessible in the form of one or more physical plugs to enable extensions by additional CPUs, GPU, and the like. The peripheral devices can be attached either directly to the core's system bus (1048), or through a peripheral bus (1049). In an example, the screen (1010) can be connected to the graphics adapter (1050). Architectures for a peripheral bus include PCI, USB, and the like.

CPUs (1041), GPUs (1042), FPGAs (1043), and accelerators (1044) can execute certain instructions that, in combination, can make up the aforementioned computer code. That computer code can be stored in ROM (1045) or RAM (1046). Transitional data can also be stored in RAM (1046), whereas permanent data can be stored for example, in the internal mass storage (1047). Fast storage and retrieve to any of the memory devices can be enabled through the use of cache memory, that can be closely associated with one or more CPU (1041), GPU (1042), mass storage (1047), ROM (1045), RAM (1046), and the like.

The computer readable media can have computer code thereon for performing various computer-implemented operations. The media and computer code can be those specially designed and constructed for the purposes of the present disclosure, or they can be of the kind well known and available to those having skill in the computer software arts.

As an example and not by way of limitation, the computer system having architecture (1000), and specifically the core (1040) can provide functionality as a result of processor(s) (including CPUs, GPUs, FPGA, accelerators, and the like) executing software embodied in one or more tangible, computer-readable media. Such computer-readable media can be media associated with user-accessible mass storage as introduced above, as well as certain storage of the core (1040) that are of non-transitory nature, such as core-internal mass storage (1047) or ROM (1045). The software implementing various aspects of the present disclosure can be stored in such devices and executed by core (1040). A computer-readable medium can include one or more memory devices or chips, according to particular needs. The software can cause the core (1040) and specifically the processors therein (including CPU, GPU, FPGA, and the like) to execute particular processes or particular parts of particular processes described herein, including defining data structures stored in RAM (1046) and modifying such data structures according to the processes defined by the software. In addition or as an alternative, the computer system can provide functionality as a result of logic hardwired or otherwise embodied in a circuit (for example: accelerator (1044)), which can operate in place of or together with software to execute particular processes or particular parts of particular processes described herein. Reference to software can encompass logic, and vice versa, where appropriate. Reference to a computer-readable media can encompass a circuit (such as an integrated circuit (IC)) storing software for execution, a circuit embodying logic for execution, or both, where appropriate. The present disclosure encompasses any suitable combination of hardware and software.

The use of “at least one of” or “one of” in the disclosure is intended to include any one or a combination of the recited elements. For example, references to at least one of A, B, or C; at least one of A, B, and C; at least one of A, B, and/or C; and at least one of A to Care intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

While this disclosure has described several examples of aspects, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

The above disclosure also encompasses the features noted below. The features may be combined in various manners and are not limited to the combinations noted below.

(1). A method of mesh decoding, including: receiving a bitstream that includes coded information of a sequence of vertices in a polygon mesh; decoding, from the coded information, a flag that indicates whether a current vertex in the sequence of vertices is a duplicate vertex with same position information as one of decoded vertices in the sequence of vertices; decoding, when the flag indicates that the current vertex is the duplicate vertex, index signal that indicates an index of a decoded vertex with the same position information of the current vertex; and determining a position of the current vertex based on a decoded position of the decoded vertex.

(2). The method of feature (1), in which the decoded vertex is a first occurrence vertex that has the same position information as the current vertex.

(3). The method of any of features (1) to (2), in which the decoded vertex is a latest occurrence vertex that has the same position information as the current vertex.

(4). The method of any of features (1) to (3), in which the index signal indicates a current delta index between a current index of the current vertex and the index of the decoded vertex, and the method includes: determining the index of the decoded vertex based on the current index of the current vertex and the index signal.

(5). The method of any of features (1) to (4), in which the index signal is a difference between the current delta index and a latest delta index that is decoded before the current delta index, and the determining the index of the decoded vertex includes: calculating the current delta index according to the index signal and the latest delta index; determining the index of the decoded vertex based on the current index of the current vertex and the current delta index; and updating the latest delta index to be the current delta index.

(6). The method of any of features (1) to (5), in which the decoding the flag includes: decoding, from the coded information, a total number of unique vertices in the sequence of vertices; counting a number of unique vertices of the decoded vertices; and inferring the flag with a value indicating that the current vertex is the duplicate vertex when the counted number of unique vertices is equal to the total number of unique vertices.

(7). The method of any of features (1) to (6), in which the flag indicates that the current vertex is not the duplicate vertex, and the method includes: generating a predicted position of the current vertex; decoding, from the coded information, a prediction residual to the predicted position; and determining the position of the current vertex based on the predicted position and the prediction residual.

(8). The method of any of features (1) to (7), further including: decoding a disable/enable flag indicating whether a coding tool for duplicate vertices is disabled/enabled.

(9). A method of mesh encoding, including: detecting that a current vertex in a sequence of vertices in a polygon mesh is a duplicate vertex with same position information as an encoded vertex in the sequence of vertices; assigning a flag with a value indicating that the current vertex is the duplicate vertex; calculating an index signal that indicates an index of the encoded vertex with the same position information as the current vertex; and encoding the flag and the index signal into coded information of the polygon mesh in a bitstream.

(10). The method of feature (9), in which the encoded vertex is a first occurrence vertex that has the same position information as the current vertex.

(11). The method of any of features (9) to (10), in which the encoded vertex is a latest occurrence vertex that has the same position information as the current vertex.

(12). The method of any of features (9) to (11), in which the calculating the index signal includes: calculating the index signal based on a current delta index between a current index of the current vertex and the index of the encoded vertex.

(13). The method of any of features (9) to (12), in which the calculating the index signal includes: calculating a difference between the current delta index and a latest delta index that is encoded before the current delta index to be the index signal; and updating the latest delta index to be the current delta index.

(14). The method of any of features (9) to (13), in which the assigning includes: counting a number of unique vertices that are encoded before the current vertex; and skipping the flag in the encoding when the number of unique vertices is equal to a total number of unique vertices in the sequence of vertices.

(15). The method of any of features (9) to (14), further including: detecting that the current vertex is not a duplicate vertex; assigning the flag with a value that indicates that the current vertex is a new vertex; generating a predicted position of the current vertex; calculating a prediction residual to the predicted position; and encoding the flag and the prediction residual into the coded information of the polygon mesh.

(16). The method of any of features (9) to (15), further including: estimating a first number of first bits for encoding the index signal; estimating a second number of second bits for encoding a prediction residual of the current vertex; encoding the flag and the index signal into the coded information when the first number is less than the second number; and encoding the prediction residual into the coded information when the second number is less than the first number.

(17). The method of any of features (9) to (16), further including: encoding, into the coded information, a disable/enable flag indicating whether a coding tool for duplicate vertices is disabled/enabled.

(18). The method of any of features (9) to (17), further including: determining that the sequence of vertices has no duplicate vertex; and disabling one or more coding tools for coding duplicate vertices.

(19). The method of any of features (9) to (18), further including: comparing a ratio of duplicate vertices to a threshold; and disabling one or more coding tools for coding duplicate vertices when the ratio is smaller than the threshold.

(20). The method of any of features (9) to (19), further including at least one of: computing the threshold based on a range of vertex positions of the sequence of vertices; and computing the threshold based on a bounding box of the vertex positions of the sequence of vertices.

(21). A non-transitory computer-readable storage medium storing instructions which when executed by a processor cause the processor to perform an encoding method, the encoding method including: detecting that a current vertex in a sequence of vertices in a polygon mesh is a duplicate vertex with same position information as an encoded vertex in the sequence of vertices; assigning a flag with a value indicating that the current vertex is the duplicate vertex; calculating an index signal that indicates an index of the encoded vertex with the same position information as the current vertex; encoding the flag and the index signal into coded information of the polygon mesh in a bitstream; and transmitting the bitstream.

(22). An apparatus for mesh decoding, including processing circuitry that is configured to perform the method of any of features (1) to (8).

(23). An apparatus for mesh encoding, including processing circuitry that is configured to perform the method of any of features (9) to (20).

(24). A non-transitory computer-readable storage medium storing instructions which when executed by at least one processor cause the at least one processor to perform the method of any of features (1) to (20).

What is claimed is:

1. A method of mesh decoding, comprising:
receiving a bitstream that includes coded information of a sequence of vertices in a polygon mesh;
decoding, from the coded information, a flag that indicates whether a current vertex in the sequence of vertices is a duplicate vertex with same position information as one of decoded vertices in the sequence of vertices;
decoding, when the flag indicates that the current vertex is the duplicate vertex, an index signal that indicates an index of a decoded vertex with the same position information of the current vertex; and
determining a position of the current vertex based on a decoded position of the decoded vertex.

2. The method of claim 1, wherein the decoded vertex is a first occurrence vertex that has the same position information as the current vertex.

3. The method of claim 1, wherein the decoded vertex is a latest occurrence vertex that has the same position information as the current vertex.

4. The method of claim 1, wherein the index signal indicates a current delta index between a current index of the current vertex and the index of the decoded vertex, and the method comprises:
determining the index of the decoded vertex based on the current index of the current vertex and the index signal.

5. The method of claim 4, wherein the index signal is a difference between the current delta index and a latest delta index that is decoded before the current delta index, and the determining the index of the decoded vertex comprises:
calculating the current delta index according to the index signal and the latest delta index;
determining the index of the decoded vertex based on the current index of the current vertex and the current delta index; and
updating the latest delta index to be the current delta index.

6. The method of claim 1, wherein the decoding the flag comprises:
decoding, from the coded information, a total number of unique vertices in the sequence of vertices;
counting a number of unique vertices of the decoded vertices; and
inferring the flag with a value indicating that the current vertex is the duplicate vertex when the counted number of unique vertices is equal to the total number of unique vertices.

7. The method of claim 1, wherein the flag indicates that the current vertex is not the duplicate vertex, and the method comprises:
generating a predicted position of the current vertex;
decoding, from the coded information, a prediction residual to the predicted position; and
determining the position of the current vertex based on the predicted position and the prediction residual.

8. The method of claim 1, further comprising:
decoding a disable/enable flag indicating whether a coding tool for duplicate vertices is disabled/enabled.

9. A method of mesh encoding, comprising:
detecting that a current vertex in a sequence of vertices in a polygon mesh is a duplicate vertex with same position information as an encoded vertex in the sequence of vertices;
assigning a flag with a value indicating that the current vertex is the duplicate vertex;
calculating an index signal that indicates an index of the encoded vertex with the same position information as the current vertex; and
encoding the flag and the index signal into coded information of the polygon mesh in a bitstream.

10. The method of claim 9, wherein the encoded vertex comprises at least one of:
a first occurrence vertex that has the same position information as the current vertex; and
a latest occurrence vertex that has the same position information as the current vertex.

11. The method of claim 9, wherein the calculating the index signal comprises:
calculating the index signal based on a current delta index between a current index of the current vertex and the index of the encoded vertex.

12. The method of claim 11, wherein the calculating the index signal comprises:
calculating a difference between the current delta index and a latest delta index that is encoded before the current delta index to be the index signal; and
updating the latest delta index to be the current delta index.

13. The method of claim 9, wherein the assigning comprises:
counting a number of unique vertices that are encoded before the current vertex; and
skipping the flag in the encoding when the number of unique vertices is equal to a total number of unique vertices in the sequence of vertices.

14. The method of claim 9, further comprising:
detecting that the current vertex is not a duplicate vertex;
assigning the flag with a value that indicates that the current vertex is a new vertex;
generating a predicted position of the current vertex;
calculating a prediction residual to the predicted position; and
encoding the flag and the prediction residual into the coded information of the polygon mesh.

15. The method of claim 9, further comprising:
estimating a first number of first bits for encoding the index signal;
estimating a second number of second bits for encoding a prediction residual of the current vertex;
encoding the flag and the index signal into the coded information when the first number is less than the second number; and
encoding the prediction residual into the coded information when the second number is less than the first number.

16. The method of claim 9, further comprising:
encoding, into the coded information, a disable/enable flag indicating whether a coding tool for duplicate vertices is disabled/enabled.

17. The method of claim 9, further comprising:
determining that the sequence of vertices has no duplicate vertex; and
disabling one or more coding tools for coding duplicate vertices.

18. The method of claim 9, further comprising:
comparing a ratio of duplicate vertices to a threshold; and
disabling one or more coding tools for coding duplicate vertices when the ratio is smaller than the threshold.

19. The method of claim 18, further comprising at least one of:
computing the threshold based on a range of vertex positions of the sequence of vertices; and
computing the threshold based on a bounding box of the vertex positions of the sequence of vertices.

20. A non-transitory computer-readable storage medium storing instructions which when executed by a processor cause the processor to perform an encoding method, the encoding method comprising:
detecting that a current vertex in a sequence of vertices in a polygon mesh is a duplicate vertex with same position information as an encoded vertex in the sequence of vertices;
assigning a flag with a value indicating that the current vertex is the duplicate vertex;
calculating an index signal that indicates an index of the encoded vertex with the same position information as the current vertex;
encoding the flag and the index signal into coded information of the polygon mesh in a bitstream; and
transmitting the bitstream.
